(19) United States
(12) Patent Application Publication
(10) Pub. No.: US 2017/0042114 A1
(43) Pub. Date: Feb. 16, 2017

(54) Disposable Animal Litter Container

(71) Applicant: Renee D. Waid, Ashtabula, OH (US)

(72) Inventor: Renee D. Waid, Ashtabula, OH (US)

(21) Appl. No.: 15/333,502

(22) Filed: Oct. 25, 2016

Related U.S. Application Data
(63) Continuation-in-part of application No. 14/990,945, filed on Jan. 8, 2016.
(60) Provisional application No. 62/100,944, filed on Jan. 8, 2015.

(51) Int. Cl. A01K 1/01

(52) U.S. Cl. CPC A01K 1/0125; A01K 1/0114

(57) ABSTRACT

There is provided a disposable animal litter container comprising a single foldable blank of material. The foldable blank of material comprises a base portion, a pair of end portions, a pair of side portions, a lid portion on each side portion, and may also include a handle portion on each lid portion. The litter container is easily constructed by a completing a series of folds and retaining tabs or adhesive strips. After use, the litter container is easily closed and transported for disposal.

### CROSS REFERENCE TO RELATED APPLICATION

This application is a Continuation in Part (CIP) application and claims priority to and the benefit of U.S. patent utility application Ser. No. 14/990,945 filed Jan. 8, 2016 and U.S. Provisional Patent Application No. 62/100,944, filed on Jan. 8, 2015 which are incorporated herein by reference in their entirety.

### TECHNICAL FIELD

This invention relates generally to litter containers designed for pets and, more particularly, to disposable litter containers that are formed as a flat blank and are easy to construct, use, and dispose of.

### BACKGROUND OF THE INVENTION

Conventional litter boxes are generally relatively large plastic boxes in which litter is placed for use. After multiple uses by a pet, such litter boxes can be unsanitary, odorous, and frustrating to empty and clean. Conventional litter boxes are generally cleaned by dumping the used litter into plastic garbage bags. These bags can be very difficult to handle due to their weight or may break, creating a mess that requires a substantial amount of clean-up. Furthermore, once the litter is emptied from the litter container, the litter container must then be cleaned out and disinfected, requiring time and labor and the ability and resources to clean and disinfect the box. For many situations, such litter boxes are not easily handled, such as for people living in apartments or condominiums for example. In such environments, disposal of the used litter may be difficult and/or the pet owner may not have access to a large sink or the like for cleaning and disinfecting the box for reuse.

Although there have been attempts at providing a disposable litter container, such devices are difficult to construct and use. Further, they do not provide any simple and convenient way for a user to cover, and transport the used litter container for disposal. Therefore, there is a need for a litter container that is formed as a flat blank for shipping and storage, and is easily constructed and used, as well as easily and quickly disposed of in a sanitary manner.

### SUMMARY OF INVENTION

The invention overcomes the shortcomings and limitations of the prior art units discussed above and teaches a disposable litter container that is easily shipped and stored, easily constructed and used, and easily closed up for simple disposal.

In some embodiments, a disposable animal litter container comprises a unitary blank of material, the blank of material comprising a base portion, a pair of end portions and a pair of side portions. The end portions are foldably connected to the base portion on opposing ends of the base portion, and the side portions are foldably connected to the base portion on opposing sides of the base portion. The end portions and side portions are positioned in diametrically opposed relationship and one of the pair of side portions or pair of end portions have an adhesive over at least a portion thereof. Upon folding up the pair of end portions, and folding up the pair of side portions, the adhesive allows each side portion to be adhered to both end portions, thereby forming an enclosed interior volume with an open top for placement of litter.

### DESCRIPTION OF THE FIGURES

The structure, operation and advantages of a presently preferred embodiment of this invention will become further apparent upon consideration of the following Description, taken in conjunction with the accompanying FIGS. and examples, wherein:

FIG. 1 is a top view of the disposable litter container in its flat, unconstructed form.

FIG. 2 is a perspective view of the disposable litter container of FIG. 1 in an initial stage of construction.

FIG. 3 is a perspective view of a constructed disposable litter container of FIG. 1.

FIG. 4 shows the disposable litter container of FIG. 1 in use.

FIG. 5 shows the disposable litter container of FIG. 1 closed after use, prior to disposal.

FIG. 6 is a top view of a sifting system for use with the container of the invention.

FIG. 7 is a perspective view of another example of the disposable litter container in its flat, unconstructed form.

FIG. 8 is a perspective view of a constructed disposable litter container of the example of FIG. 7.

FIG. 9 is a perspective view of another example of the disposable litter container in its flat, unconstructed form.

FIG. 10 is a perspective view of a constructed disposable litter container of the example of FIG. 9.

FIG. 11 is a perspective view of another example of the disposable litter container in its flat, unconstructed form.

### DETAILED DESCRIPTION OF THE INVENTION

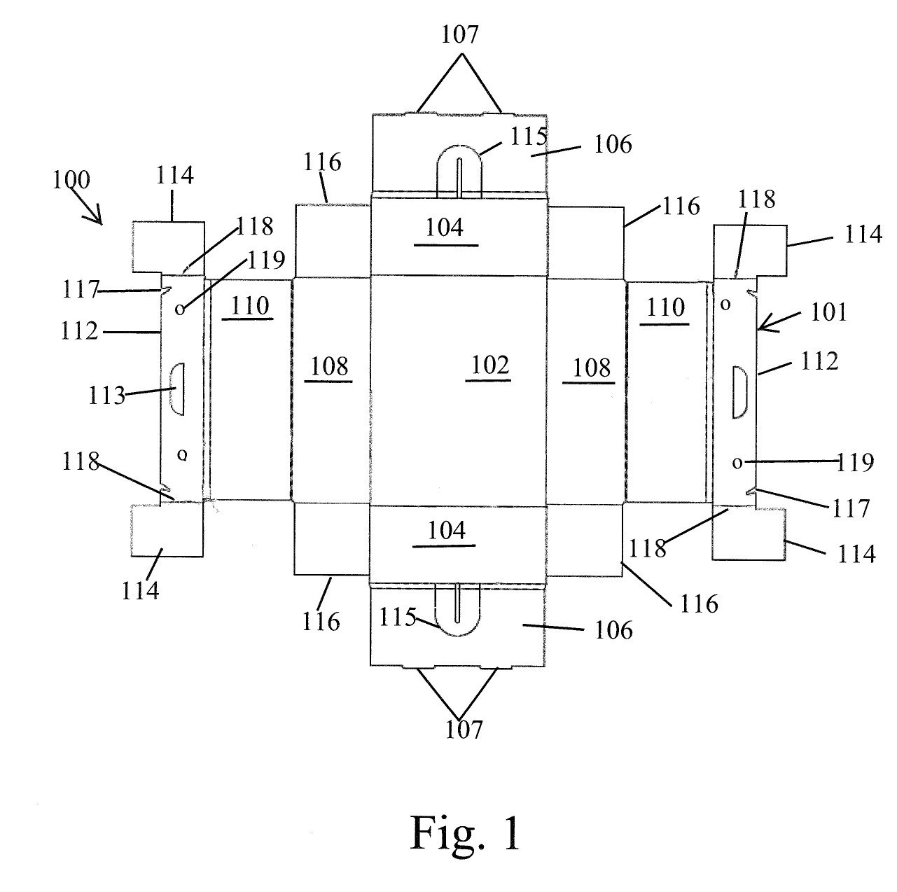

Referring now to FIG. 1, an example of a disposable litter container 100 according to the invention is shown. The container 100 in this example is formed as a unitary flat blank of material 101 having an interior or top surface and exterior or bottom surface. The blank 101 can be shipped and stored as a flat sheet or as a pack of multiple flat blanks 101. In this manner, the disposable litter container 100 is easily stored until use is desired, making it ideal for environments where storage space is limited, such as apartments or condominiums. In this example, the flat blank of material 101 comprises of a base portion 102. A pair of end portions 104 are provided on opposing sides of the base 102. A retaining panel 106 is provided on the distal end of each of the end portions 104. A pair of side portions 108 are provided on the other opposing sides of the base 102. A pair of lid or top portions 110 are provided on the distal sides of each side portion 108, and a pair of handle portions 112 are provided on the distal sides of each top portion 110. At the sides of handle portions 112, retaining tabs 114 are provided. The retaining tabs 114 have a separable fold line connection 118 to the handle portions 112. Further retaining tabs 116 are provided on the outside edges of the side portions 108. The end portions 104 are foldably connected on opposing ends of the base portion 102. The side portions 108 are foldably connected on the other opposing sides of the base portion 102. The pair of retaining tabs 114 are foldably connected on the opposing sides of the side portions 108 adjacent the end portions 104. The lid portions 110 are foldably connected to each side portion 108. The handle portions 112 are foldably connected to each lid portion 110. Each handle portion 112 may include a cutout 113 that allows grasping by the fingers when the container 100 is in its closed configuration as will be described. The foldable connections between portions in the flat blank of material 101 may be formed by perforating, scoring or otherwise, to make weakened zones which are easily folded.

In an embodiment, the flat blank of material 101 may be made of cardboard. At least a portion of the flat blank of material 101 has a moisture proof coating in order to prevent urine or other waste from damaging the material or leaking out. In an example, a wax or other moisture proof coating may be provided on the interior side of the bottom portion 102, and to ensure no leakage, on the interior side of the end portions 104 and side portions 108. Further, the flat blank of material 101 may be made of biodegradable material. In further examples, the flat sheet of material 100 may be scented and/or formed to have the exterior surface colored or imprinted with a design or other decoration to enhance use in a living space.

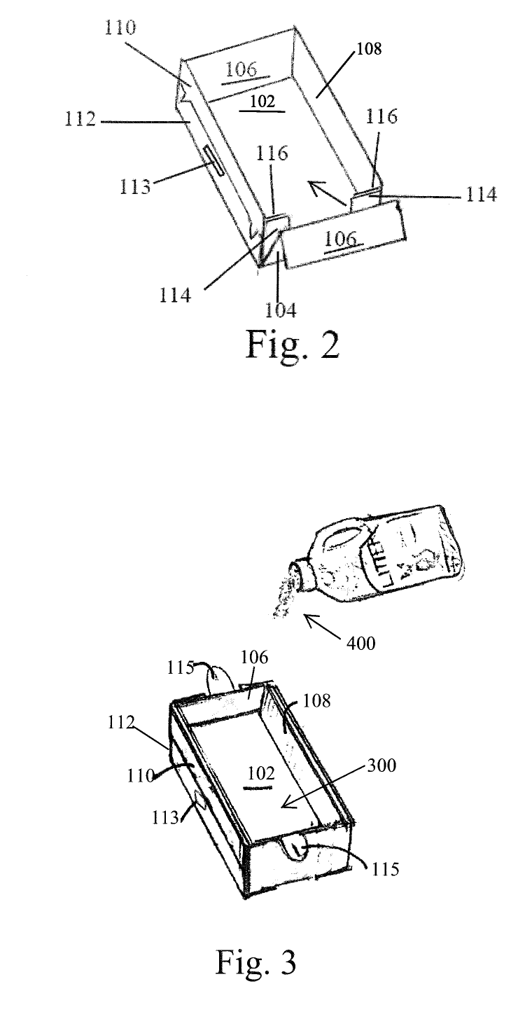

Referring now to FIG. 2, the disposable animal litter container 100 is constructed by first folding up the pair of side portions 108 about the base 102 so that the angle between the base portion 102 and the side portions 108 is approximately 90°. The next step involves folding up the opposing retaining tabs 116 on both side portions 108 to be approximately 90° relative to the side portions 108. The lid portions 110 are folded to a position adjacent the upstanding side portions 108, and handle portions 112 are folded to a position adjacent the upstanding lid portions 110 as seen in FIG. 2. The retaining tabs 114 are folded into a position adjacent the upstanding, folded retaining tabs 116. The end portions 104 are then folded about the base 102 to be positioned perpendicularly adjacent the base 102 and to engage or capture the upstanding retaining tabs 116 and 114 in each corner. The retaining panels 106 are then folded over the top of the upstanding retaining tabs 116 and 114 in each corner and to a position adjacent the upstanding end portions 104 to engage and retain the upstanding retaining tabs 116 and 114 in each corner, and sides 108 in position. As seen in FIG. 1, the retaining panels 106 may have tabs 107 that extend outwardly an amount to frictionally engage the bottom panel 102 when folded into position. As an alternative, the end portions 104 could be provided with a retaining tab portion to allow the end portions 104 to be secured in association with the side portions 108 when the container 100 is assembled as will be described below. As noted in FIG. 1, the foldable connections between the base 102, end portions 104, side portions 108, and the various retaining tabs 114 and 116 and retaining panels 106 of the container 100 are dimensioned to allow these structures to be positioned adjacent one another in the upstanding configuration, to accommodate the thickness of the material from which the blank 101 is made.

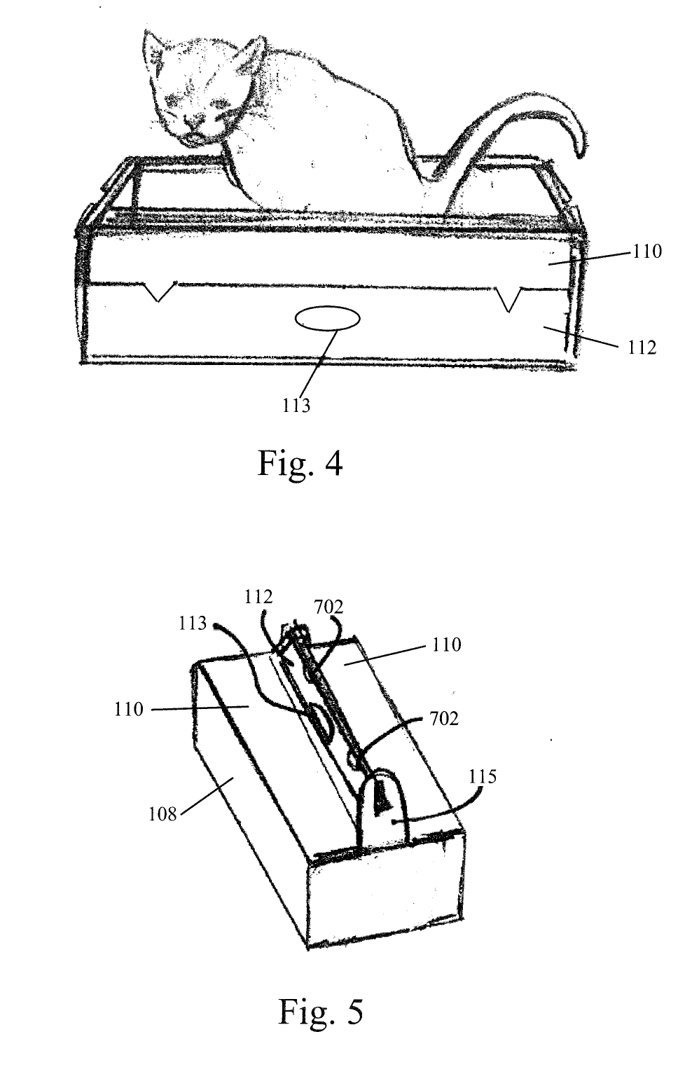

As seen in FIG. 3, this construction forms an enclosed interior volume 300 with an open top. In this configuration, an amount of animal litter 400 may be introduced into the interior volume and as seen in FIG. 4, an animal has access to the interior 300. The accordion-style folding of lid portions 110 and handled portions 112 into adjacent relationship with side portions 108, and retaining panels 106 into adjacent relationship with end portions 104, provides additional support to make the formed container 100 into a rigid construction and allow it to be portable even with litter therein. Once the litter container 100 is constructed and in its operative condition, it is capable of receiving and holding desired amount of animal litter 400 for use thereof. The disposable litter container 100 may be a variety of sizes to accommodate different animals or animals of different sizes. In an exemplary embodiment, the litter container 100 is about seventeen inches in length, fourteen inches in width, and seven inches in height when in its operative configuration as shown in FIG. 3.

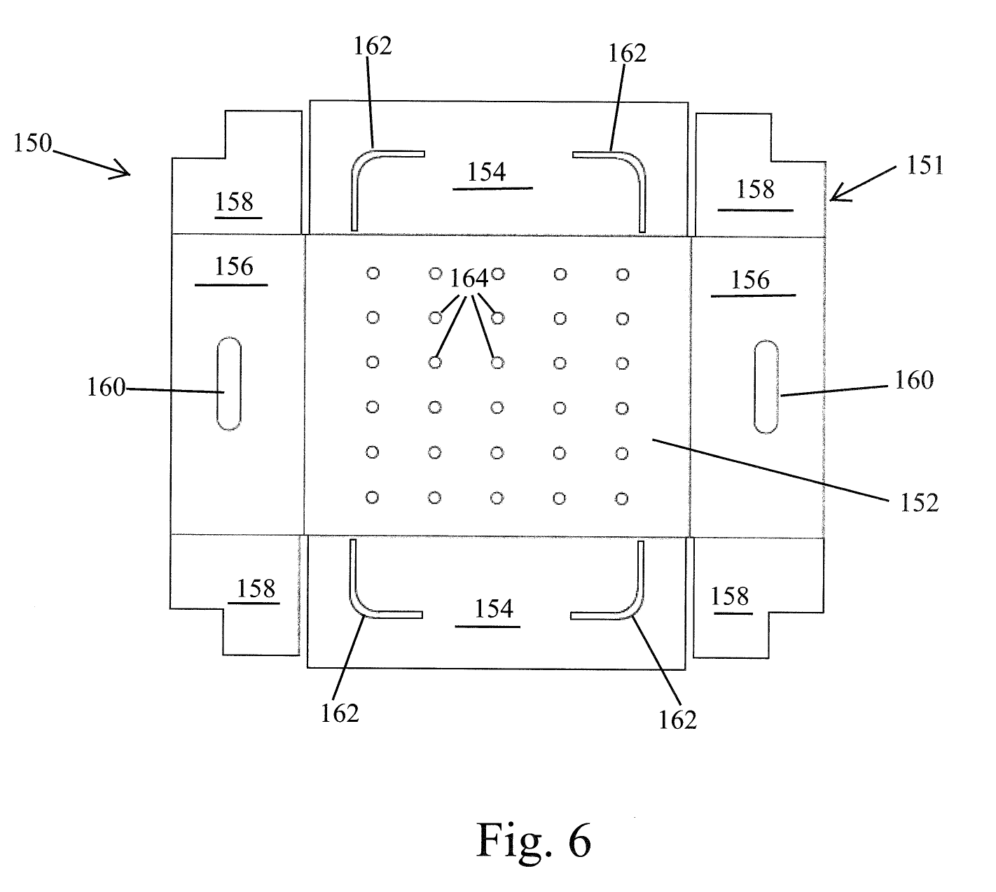

Referring now to FIG. 5, when it is time for the disposable litter container 100 to be disposed of, the handle portions 112 are separated from the retaining tabs 114 at the separable folded connection 118 to disengage the handle portions 112 and lid portions 110 at the corners. The separable connections 118 may be formed by perforation or in another suitable manner to allow tearing of the fold line. The lid portions 110 are then unfolded and lifted up to be brought in towards each other in such a fashion that the lid portions 110 close the top of the enclosed interior volume 300. The handle portions 112 are brought together so that the openings 113 are aligned with and adjacent each other. At this point, the interior volume 300 of the disposable litter container 100 is completely enclosed, and effectively sealed to enclose the used litter and odors associated therewith. Associated with each end portion 104 may be a latch tab 115 which is used to secure the lid portions 110 and handle portions 112 in the closed position when the disposable litter container 100 is closed. The latch tabs 115 may comprise an opening such as a slot or a hole. The latch tabs 115 may be folded up so that the corners of the handle portion 112 can be inserted into the slot, hole, or other opening located in the latch tabs 115. In an embodiment, each handle portion 112 comprises a notch 117 on each end that engages and is secured by the corresponding latch tab 115. Alternatively or in addition, there may be provided one or more adhesive tabs 119 (see FIG. 1) on one or both of the handle portions 112, to allow the handle portions 112 to be secured to one another when in this closed position. In another embodiment, at least one adhesive tab 702 (see FIG. 5) is provided to allow the handle portions 110 to be secured to one another. The adhesive tab 702 is placed over both handle portions 112 at the point where the two handle portions 110 meet. The purpose of the adhesive tab(s) 119 or adhesive tab(s) 702 is to seal the disposable litter container 100 in preparation for transportation for disposal. FIG. 6 shows a, sealed disposable litter container 100. At this point, the sealed disposable litter container 100 may be easily lifted by the handle portions 112 via the openings 113 which are aligned with one another, to allow transportation and disposal with no mess. The contents of the litter container 100, which may include animal litter and animal waste, are sealed within the interior volume.

In certain embodiments, the disposable litter container 100 is packaged as a kit. The kit may comprise one or more flat blanks of material 101, an amount of animal litter 400, and if desired, other parts such as sealing adhesive tabs 702 or the like, and instructions. The flat blank(s) of material 101, animal litter 400, and adhesive tab may be biodegradable.

In association with the container 100 of this example, there may also be provided one or more sifter systems 150, as shown in FIG. 6. In this example, the sifter system 150 is a separate flat blank of material 151 that is constructed to form a open top container portion that fits within container 100. Litter material can be introduced into the sifter system 150 once placed into the container 100. The flat blank 151 may also be formed of biodegradable cardboard or other suitable material, and have a moisture proof coating if needed. The blank 151 can be shipped and stored as a flat sheet or as a pack of multiple flat blanks along with flat blanks 101 of container 100. In this example, the flat blank of material 151 comprises of a base portion 152. A pair of end portions 154 are provided on opposing ends of the base 152. A pair of side portions 156 are provided on the other opposing sides of the base 152. A retaining panel 158 is provided on the edges of each of the side portions 156. The side portions 156 may have handle opening 160 provided therein. Retaining slots 162 may be formed in the end portions 154. When construction of the sifting system 150 is desired, the end portions 154 and side portions 156 are folded to about perpendicular with respect to the bottom 152, and the retaining tabs 158 are inserted into the retaining slots 162 to maintain the system 150 in an open top container configuration that is positionable into the interior volume 300 of container 100 for example. The bottom portion 152 is formed with a plurality of slits or holes 164 sized so that unused portions of the animal litter may pass through, but animal waste and dirty clumps of litter remain in the sifter system 150 when it is lifted through the litter that is placed therein. Any suitable number, configuration and size of holes 164 may be used. The handle portions 160 may be provided at each end of the sifter system 150 to allow it to be picked up and lifted after litter is introduced into the interior volume of container 100. In this manner, the disposable litter container 100 may be used for an extended period as animal waste and dirty clumps of litter may be periodically removed from the litter for continued use of clean litter. As the sifter system 150 is lifted, any clean, reusable granules of animal litter fall through system 150 and down into the interior volume 300 for continued use. Multiple systems 150 may be nested in container 100 for multiple cleanings of waste from container 100. The user may then add additional animal litter if needed.

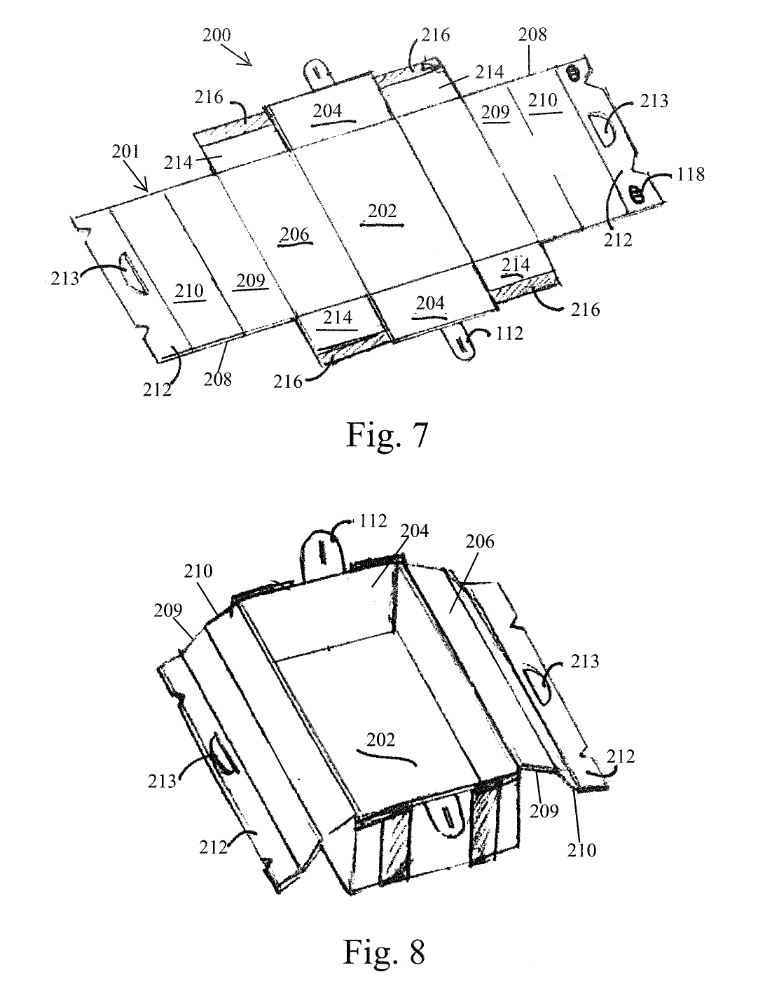

In another example as shown in FIGS. 7 and 8, another example of the disposable litter container of the invention is shown. In this example, the disposable litter container 200 may again be formed as a unitary flat blank of material 201 having an interior or top surface and exterior or bottom surface. The blank 201 can be shipped and stored as a flat sheet or as a pack of multiple flat blanks 201. In this example, the flat blank of material 201 comprises of a base portion 202. A pair of opposing end portions 204, a pair of opposing side portions 206, a pair of lid portions 208 associated with each side portion 206 and formed of first and second panels 209 and 210, and a pair of handle portions 212. The end portions 204 are foldably connected on opposing ends of the base portion 202. The side portions 206 are foldably connected on the other opposing sides of the base portion 202. Each side portion 206 comprises a pair of opposing connecting tabs 214 adjacent the end portions 204. Each connecting tab 214 has an adhesive strip 216 provided on the outside edge of the connecting tab 214. The adhesive strip 216 may have a removable release liner to protect the adhesive until use is desired. Alternatively, the end portions 204 could be provided with a retaining tab portion with an adhesive to allow the end portions 204 to be secured to the side portions 206 when the container 200 is assembled. Other suitable mechanisms for securing the end portions 204 and side portions 206 to form the open interior volume container similar to the embodiment of FIG. 1 may be used. A lid portion 208 is foldably connected to each side portion 206. A handle portion 212 is foldably connected to each lid portion 208. Each handle portion 212 may include a cutout 213 that functions as a handle when the container 200 is in its closed configuration as in the previous example. The foldable connections between portions in the flat blank of material 101 may be formed by preforation or scoring of the material to make a weakened zone which is easily folded, or in another suitable manner.

As in the prior example, the flat blank of material 201 may be made of cardboard, with a moisture proof coating in order to prevent urine or the like from damaging the material or leaking out, and again may be made of biodegradable material, scented and/or formed to have the exterior surface colored or imprinted with a design or other decoration to enhance use in a living space. Referring now to FIGS. 7 and 8, the disposable animal litter container 200 is constructed by first folding up the pair of end portions 204 so that the angle between the base portion 202 and the end portions 204 is approximately 90°. The next step involves folding up both side portions 206 to perpendicularly meet the end portions 204. The side portions 206 are connected to the end portions 204 by way of the adhesive strips 216 on the connecting tabs 214. This adhesion is accomplished by first removing a release liner from the adhesive strips 216 on the connecting tabs 214. The connecting tabs 214 are then bent inward and pressed against the corresponding end portion 204 so that the adhesive strips 216 hold the side portions 206 securely in place perpendicular to the end portions 204 as shown in FIG. 8.

As shown in FIGS. 7 and 8, the lid portions 208 include a plurality of panels 209 and 210 that are foldable into a position adjacent the side portions 206, until the lid portions 208 and handle portions 212 are released and moved to the closed position. The plurality of panels 209 and 210 in lid portions 208 may be secured in the position adjacent the side portion 206 by an adhesive tab or tabs provided on the exterior surfaces of each panel section. In this manner, the lid portions 208 and handle portions 212 can be folded down to be positioned adjacent the exterior of the side portions 206 and secured to the side portions 206 so that they do not take up extra space or interfere with an animal attempting to use the disposable litter container 200. Other suitable methods for securing the lid portions 208 and handle portions 212 to the exterior of the side portions 206 may be used. For example, as an alternative to the use of an adhesive, hook and loop fasteners, tape, or the like may be used. The accordion-style fold of the plurality of panels in the lid portions 209 and 210 also offers additional side support for the constructed container 200. Once the litter container 200 is constructed and in its operative condition, it is capable of receiving and holding animal litter. To close the container 200, the top or lid portions 208 and handle portions 212 are released from engagement with the side portions 206 and moved to the closed position to be closed in a manner similar to the previous example.

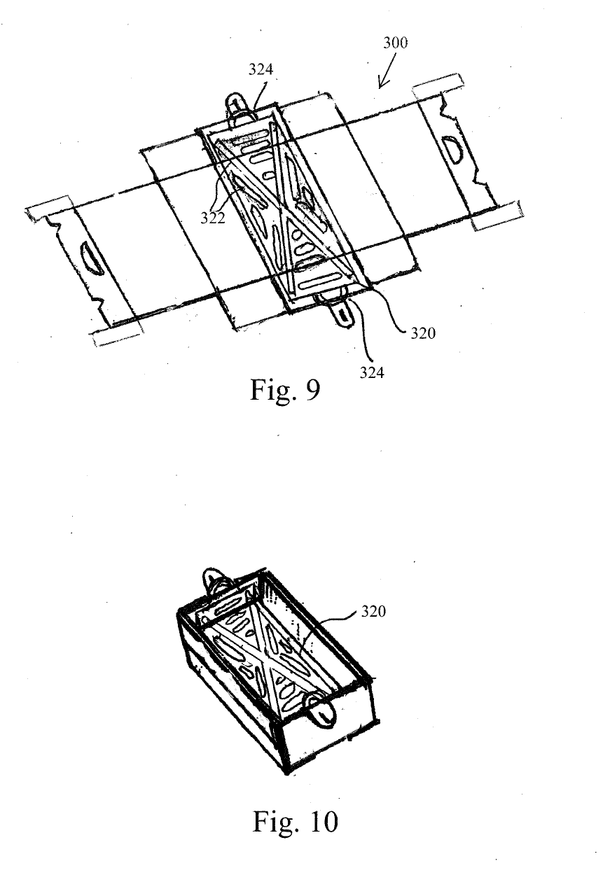

In another example as shown in FIGS. 9 and 101, a container 300 may be provided with one or more sifter sheets 320 in association therewith. The sifter sheets 320 may comprise a plastic sheet having a plurality of slits or holes 322 sized so that unused portions of the animal litter may pass through, but animal waste and dirty clumps of litter remain in the sifter sheet 320 when it is lifted through the litter that is used to fill the container 300 for use. Any suitable number, configuration and size of holes 322 may be used. A handle portion 324 may be provided at each end of the sifter sheet 320 to allow the sheet 320 to be picked up and lifted after litter is introduced into the interior volume of container 300. In this manner, the disposable litter container 300 may be used for an extended period as but animal waste and dirty clumps of litter may be periodically removed from the litter for continued use of clean litter. As the sifter sheet 320 is lifted, any clean, reusable granules of animal litter fall through sheet 320 and back into the container 300 for continued use. The user may then add additional animal litter if needed. If a plurality of sifter sheets 320 are provided, an individual sheet may be separated from any others to allow removal of animal waste and dirty clumps of litter successively.

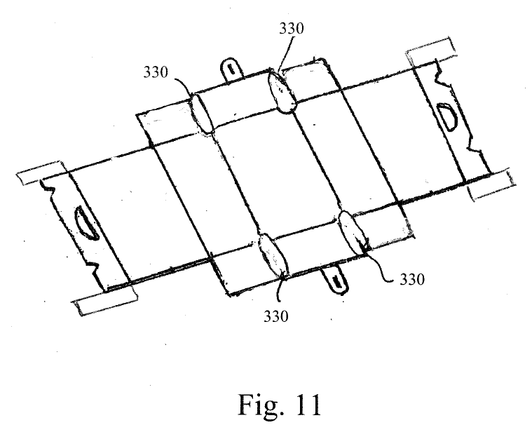

In another example, there are provided sealing tabs 330 as shown in FIG. 11, adjacent the intersection of the end portions and side portions of a container according to any of the examples of the invention. The sealing tabs 330 may be formed of a moisture proof material and provided with an adhesive on a portion thereof adjacent this intersection. A release liner may protect the adhesive until use is desired. Upon making the container into the form for use with the end portions and side portions positioned in their upstanding, perpendicular relationship to one another, the adhesive on the sealing tabs 330 may be exposed and the tabs 330 pressed into and secured in association with the corners formed at the intersection of the end portions and side portions. In this manner, the sealing tabs effectively seal each of the interior corners formed around the interior volume of the container to prevent any egress of urine or moisture from the formed container.

It is intended that the invention not be limited to the particular embodiments disclosed as the best mode contemplated for carrying out this invention, but that the instant invention will include all embodiments falling within the scope of the appended claims.

What is claimed is:

1. A disposable animal litter container comprising
a unitary blank of material, the blank of material comprising
a base portion;
a pair of end portions, the end portions foldably connected to the base portion on opposing ends of the base portion;
a pair of side portions, the side portions foldably connected to the base portion on opposing sides of the base portion; and
at least one retaining panel;
wherein the end portions and side portions are positioned in diametrically opposed relationship and one of the pair of side portions or pair of end portions are retained with the other in association with the at least one retaining panel when folded into adjacent relationship with one another, thereby forming an enclosed interior volume with an open top for placement of litter therein.

2. The disposable animal litter container of claim 1 further comprising a lid portion foldably connected to each side portion, and a handle portion foldably connected to each lid portion.

3. The disposable animal litter container of claim 2 wherein upon moving the lid portions to the closed position, the opposing handle portions are positioned adjacent one another for grasping.

4. The disposable animal litter container of claim 3 wherein the pair of end portions each comprise a latch tab which receives an end of the handle portions when adjacent one another to lock the lid portions and handle portions in position.

5. The disposable animal litter container of claim 3 further comprising an adhesive provided on at least one of the opposing handle portions to secure the handle portions together when positioned adjacent one another.

6. The disposable animal litter container of claim 1 wherein at least the interior side of the foldable piece of material is moisture proof.

7. The disposable animal litter container of claim 2 wherein at least one handle portion has an adhesive to allow the handle portions to be secured to one another upon the lid portions being moved to the closed position and the opposing handle portions moved to be adjacent one another.

8. The disposable animal litter container of claim 1 further comprising a sifter system having a plurality of openings sized so that unused portions of litter may pass through, but animal waste and dirty clumps of litter remain in the sifter system when it is lifted.

9. The disposable animal litter container of claim 8 wherein the sifter system is made from a foldable blank of material that fits into the interior volume of the container.

10. The disposable animal litter container of claim 8 wherein the sifter system is a plurality of sifter sheets wherein an individual sifter sheet may be separated from any others to allow removal of animal waste and dirty clumps of litter successively.

11. The disposable animal litter container of claim 2 wherein the lid portions include a plurality of panels that are foldable into a position adjacent the side portion until the lid portion is moved to the closed position.

12. The disposable animal litter container of claim 1 further comprising a lid portion foldably connected to each side portion, and a handle portion foldably connected to each lid portion, wherein the blank of material includes a first retaining tab on opposing edges of the side portions and a second retaining tab on opposing edges of the handle portions, the first and second retaining tabs being folded into adjacent relationship with the side portions when folded to be approximately perpendicular to the base portion, and a retaining panel provided on the distal end of each of the end portions that is foldable to capture the first and second retaining tabs adjacent the end portions.

13. A disposable animal litter container comprising
a unitary blank of material comprising a base portion, a pair of opposing end portions and a pair of opposing side portions, the end portions and side portions foldably connected to the base portion on opposing sides of the base portion, and a pair of lid portions foldably connected to each side portion,
wherein the end portions and side portions are positioned in diametrically opposed relationship and one of the pair of side portions or pair of end portions have an adhesive over at least a portion thereof, such that upon folding up the pair of end portions, and folding up the pair of side portions, the adhesive allows each side portion to be adhered to both end portions, thereby forming an enclosed interior volume with an open top for placement of litter therein, and the lid portions movable into a closed position over the interior volume for disposal.

14. The disposable animal litter container of claim 13 further comprising sealing tabs positioned adjacent the corners formed upon folding up the pair of end portions and pair of side portions, wherein the sealing tabs are pressed into and secured in association with the corner formed at the intersection of the end portions and side portions to seal the corners of the interior volume.

15. The disposable animal litter container of claim 14 wherein the sealing tabs are formed of a moisture proof material.

16. The disposable animal litter container of claim 14 wherein the sealing tabs are provided with an adhesive on a portion thereof adjacent the intersection of the end portions and side portions.

17. The disposable animal litter container of claim 13 further comprising a handle portion on each lid portion, with at least one handle portion having an adhesive to allow the handle portions to be secured to one another upon the lid portions being moved to a closed position wherein the opposing handle portions are correspondingly moved to be adjacent one another.

18. The disposable animal litter container of claim 12 further comprising at least one sifter sheet having a plurality of openings sized so that unused portions of litter may pass through, but animal waste and dirty clumps of litter remain in the sifter sheet when it is lifted.

19. The disposable animal litter container of claim 18 further comprising a plurality of sifter sheets wherein an individual sifter sheet may be separated from any others to allow removal of animal waste and dirty clumps of litter successively.

20. A kit for the construction and use of a disposable animal litter box, the kit comprising
at least one unitary flat blank of material comprising
a base portion, a pair of opposing end portions and a pair of opposing side portions, the end portions and side portions foldably connected to the base portion on opposing sides of the base portion, and a lid portion foldably connected to each side portion; and
an amount of animal litter.
